(19) United States
(12) Patent Application Publication
(10) Pub. No.: US 2018/0371810 A1
(43) Pub. Date: Dec. 27, 2018

(54) Door Barricade System

(71) Applicant: James Stephen Howard, Waynesburg, PA (US)

(72) Inventor: James Stephen Howard, Waynesburg, PA (US)

(21) Appl. No.: 15/850,411

(22) Filed: Dec. 21, 2017

Related U.S. Application Data
(60) Provisional application No. 62/437,579, filed on Dec. 21, 2016.

(51) Int. Cl. E05C 19/18

(52) U.S. Cl. CPC E05C 19/184

(57) ABSTRACT

A door barricade system includes a bracket attached to an inside of a door. The door barricade system also includes a removable puncture pin and an end sleeve recessed into a support structure. The bracket includes a pin sleeve which defines a through hole aligned with an opening defined by an end sleeve, both of which are large enough to accommodate the puncture pin. The puncture pin is engaged with the pin sleeve with an end of the puncture pin being able to be engaged with the end sleeve. When the end of the puncture pin is engaged with the end sleeve, the door barricade system is placed in a locked position. When the end of the puncture pin remains disengaged from the end sleeve, the door barricade system is placed in an unlocked position.

### CROSS REFERENCE TO RELATED APPLICATIONS

This application claims the benefit of U.S. Provisional Patent Application No. 62/437,579, filed Dec. 21, 2016, and entitled “The Ultimate Lockdown Hammer Pin”, which is hereby incorporated by reference in its entirety.

### BACKGROUND OF THE INVENTION

### Field of the Invention

The present invention relates generally to door locking systems, and more specifically relates to an interior barricade system.

### Description of Related Art

Security for homes and other buildings is of concern for all owners and occupants of such properties and particularly in areas where high concentrations of breaking and entering or other crimes occur. In many instances, such as with break-ins, active shooter situations, and other emergencies, it may be necessary to quickly secure a room or building from an outside area. Often in these situations, it is recommended to barricade a door in order to prevent or delay an unwanted individual from entering the room or gaining access to the people and or items in the room. However, individuals in these situations might find themselves stranded in a room without chairs, desks, and other large items, therefore making it impossible to barricade the door. Furthermore, this approach may be time consuming and physically exhausting or impossible to move the objects in front of the door. Such a barricade method does not account for those situations where a person may need to be let back inside of the room if they were not present when the barricading took place. A barricade method that does not require lifting would facilitate easier use of such systems and provide greater protection than weaker conventional locks.

Often times, a standard lock is ineffective as the unwanted individual simply forces their way through the door. Furthermore, many standard locks can be accessed from both sides of the door, thereby allowing any individual to manipulate or break the lock from outside of the room. Furthermore, other forms of locks are located high up on the door or require a significant amount of physical strength to actuate. This may prevent individuals of a short height, persons confined to a wheelchair, or persons of limited physical strength from being able to use these door barricade systems. Furthermore, many of the devices in the prior art are complicated to operate or may be unsafe, increasing the likelihood of injury while operating the device as well as the inability to effectively barricade the door in time to prevent an intrusion. Therefore, there is a need for a system that provides better protection that conventional locks, is easy for all individuals to use, and effectively secures a door from any unwanted individuals.

In light of these and other deficiencies in the existing art, it is an object of the present invention to provide a door barricade system that is convenient for all individuals to use and effectively barricades the door. This device does not rely on keys or any other mechanisms that can be manipulated from outside of the room. Furthermore, it can be installed lower to the ground that other devices in the prior art and provides a simpler method of use and installation to allow any type of user to be able to efficiently barricade themselves within the desired room.

### SUMMARY OF THE INVENTION

The present invention is directed to a door barricade system which improves upon the prior art and solves the prior art problems by providing increased door security to strengthen the door against breaching with a simple device that allows any user to quickly and effectively barricade a door.

In a non-limiting embodiment, the door barricade system includes a bracket configured to attach to an inside of a door. The door barricade system also includes a removable puncture pin and an end sleeve recessed into a support structure. The bracket includes a pin sleeve which defines a through hole large enough to accommodate the removable puncture pin. The end sleeve also defines an opening large enough to accommodate the removable puncture pin where the opening defined by the end sleeve is aligned with the through hole defined by the pin sleeve. The removable puncture pin is able to be engaged with and inserted through the through hole defined by the pin sleeve with an end of the removable puncture pin being able to be engaged with and inserted into the opening defined by the end sleeve. When the removable puncture pin is inserted into and engaged with the through hole defined by the pin sleeve and the end of the removable puncture pin is inserted into and engaged with the opening defined by the end sleeve, the door barricade system is placed in a locked position preventing the door from being opened from the outside. When the removable puncture pin is inserted into and engaged with the through hole defined by the pin sleeve and the end of the removable puncture pin remains disengaged from the opening defined by the end sleeve, the door barricade system is placed in an unlocked position allowing the door to be opened.

In a non-limiting embodiment, the bracket is attached to the door via a plurality of bolts, a plurality of washers, and a plurality of nuts, with the plurality of bolts extending into a plurality of through holes defined by the bracket and into the inside of the door, thereby securing the bracket to the door.

In a non-limiting embodiment, the bracket is configured to correspond with a bracket system, where the bracket system is configured to be attached to the door and allows the bracket to be removed from the door.

In a non-limiting embodiment, the bracket is attached to a bottom inside of the door and the support structure which the end sleeve is recessed into is a floor.

In a non-limiting embodiment, the bracket is attached to an inside side edge of the door and the support structure which the end sleeve is recessed into is a vertical side of a door frame.

In a non-limiting embodiment, the bracket is attached to the inside side edge of the door and the support structure which the end sleeve is recessed into is a wall surface adjacent to a vertical side of a recessed door frame.

In a non-limiting embodiment, the bracket is located on a side of the door opposite a hinged side of the door.

In a non-limiting embodiment, a through hole is defined in the removable puncture pin and a corresponding through hole is defined in the pin sleeve so that a pin can be inserted through the through holes defined in the removable puncture pin and the pin sleeve to hold the removable puncture pin in place.

In a non-limiting embodiment, the through holes defined by the removable puncture pin and the pin sleeve are located so that the removable puncture pin remains engaged with the opening defined by the end sleeve and the door barricade system is maintained in a locked position.

In a non-limiting embodiment, the through holes defined by the removable puncture pin and the pin sleeve are located so that the removable puncture pin remains disengaged from opening defined by the end sleeve and the door barricade system is maintained in an unlocked position.

In a non-limiting embodiment, the removable puncture pin is threaded and at least one of the through holes defined by the pin sleeve and the end sleeve are threaded.

In a non-limiting embodiment, a plurality of brackets can be attached onto the inside of the door, and a plurality of puncture pins are provided along with a plurality of end sleeves to correspond with the plurality of brackets.

In a non-limiting embodiment, the removable puncture pin can be removed entirely from the bracket and also be used as a defensive weapon or window-breaching tool.

In a non-limiting embodiment, a door can be barricaded with a door barricade system by mounting a bracket onto an inside of the door at a location where the bracket is close enough to a support structure so that a removable puncture pin can engage both a through hole defined by a pin sleeve of the bracket and an opening defined by an end sleeve recessed into the support structure. Then recessing the end sleeve into the support structure so that the opening defined by the end sleeve is aligned with the through hole defined by the pin sleeve of the bracket and inserting the removable puncture pin into and through the through hole defined by the pin sleeve. Engaging an end of the removable puncture pin with the opening defined by the end sleeve places the door barricade system in a locked position and disengaging the end of the removable puncture pin with the opening defined by the end sleeve places the door barricade system in an unlocked position.

### BRIEF DESCRIPTION OF THE DRAWINGS

FIG. 1 is a close-up front side view of the door barricade system attached to the bottom of a door;

FIG. 2 is a front side view of the door barricade system attached to the bottom of a door;

FIG. 3 is a front side view of the door barricade system unattached;

FIG. 4 is a front side view of the bracket for the door barricade system of FIG. 1; and

FIG. 5 is the hammer pin for the door barricade system of FIG. 1.

### DESCRIPTION OF THE INVENTION

For the purposes of the description hereinafter, the terms “upper”, “lower”, “right”, “left”, “vertical”, “horizontal”, “top”, “bottom”, “side”, “front”, “back”, “longitudinal”, and derivatives thereof shall relate to the invention as it is oriented in the drawing figures. Furthermore, it is understood that when referring to terms such as “door barricade system” this includes other terms such as “barricade” and similar terms which are synonymous to “barricade” in the art. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and physical characteristics related to the embodiments disclosed herein are not to be considered as limiting. As used throughout the drawings, like reference numerals refer to like components or method steps unless otherwise indicated.

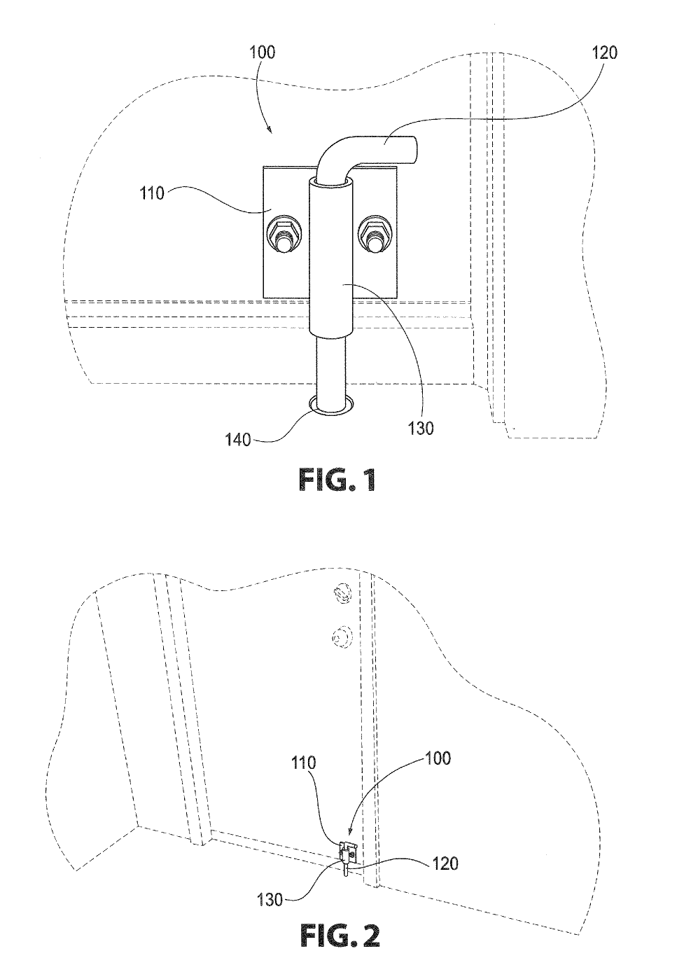

The present invention is directed to a door barricade system 100 for better securing doors from intrusions or breaches. Referring to FIG. 1, one embodiment of the door barricade system 100 includes a bracket 110. The bracket 110 of the door barricade system 100 is configured to attach to the inside of any type of door. The door barricade system 100 also includes a removable puncture pin 120. A pin sleeve 130 is attached to the surface of the bracket 110 facing away from the door. The pin sleeve 130 defines a through hole which is large enough to accommodate and engage with the removable puncture pin 120. The end sleeve 140 is a separate sleeve from the bracket 110. The end sleeve 140 also defines an opening large enough to accommodate and engage with the removable puncture pin 120. The end sleeve 140 is recessed into a support structure to hold the end sleeve 140 and to provide a secondary structure besides the door for the door barricade system 100 to be connected with, thereby providing additional barricade strength for the door. The end sleeve 140 does not require a through hole, as the end sleeve 140 can have a closed end for the end of the end sleeve 140 that was first inserted into the support structure, with the closed end being meant to engage with and stop the end of the removable puncture pin 120. The opening defined by the end sleeve 140 aligns with the through hole defined by the pin sleeve 130. The removable puncture pin 120 being engaged with and inserted through the through hole defined by the pin sleeve 130 and the end of the removable puncture pin being inserted into and engaged with the end sleeve 140 places the door barricade system is a locked position, thereby preventing the door from being opened and effectively preventing exterior entry. The removable puncture pin 120 being engaged with and inserted through the through hole defined by the pin sleeve 130 with the end of the removable puncture pin 120 remaining entirely outside of and disengaged from the end sleeve 140 places the door barricade system in an unlocked position, thereby allowing the door to be opened.

The removable puncture pin 120 can be cylindrical in shape. The through hole defined by the pin sleeve 130 and the opening defined by the end sleeve 140 can also be cylindrical to correspond with the shape of the removable puncture pin 120. The removable puncture pin 120 as well as the through hole of the pin sleeve 130 and the opening of end sleeve 140 do not have to be cylindrical in shape. Any reasonable shape within the prior art is acceptable so long as the shape of the removable puncture pin 120 corresponds with the shape defined by the through hole of the pin sleeve 130 and the opening of end sleeve 140, so that the removable puncture pin 120 can be inserted into and engage with the pin sleeve 130 and the end sleeve 140.

Referring to FIG. 2, in one embodiment of the door barricade system 100, the bracket 110 is attached to a bottom inside of the door. The end sleeve 140 is then recessed into the floor as seen in FIG. 1. In this embodiment, the removable puncture pin 120 directly engages with the end sleeve 140 recessed into the floor, thereby increasing the barricade strength of the door.

In another embodiment, the bracket 110 can be attached to the inside side edge of the door. The end sleeve 140 in this embodiment would be recessed into the vertical side of a door frame, such as the side of the vertical doorpost that faces towards the door. In this embodiment, the removable puncture pin 120 directly engages with the end sleeve 140 recessed into the vertical side of the door frame, thereby increasing the barricade strength of the door.

In another embodiment where the bracket 110 is attached to the inside side edge of the door, the end sleeve 140 can be recessed into a wall within close proximity to the door, such as a wall surface adjacent to the vertical side of a recessed door frame. In this embodiment, the removable puncture pin 120 directly engages with the end sleeve 140 recessed into the wall surface adjacent to the vertical side of a recessed door frame, thereby increasing the barricade strength of the door.

In the above embodiments where the bracket 110 is attached to the bottom inside of the door or the inside side edge of the door, it is preferable that the bracket be placed on the opening side of the door (as seen in FIGS. 1 and 2) rather than the hinged side of the door where the rotation of the door occurs. This is preferable as the non-hinged side of the door is often the less reinforced and less resistant side of the door during a breach or intrusion.

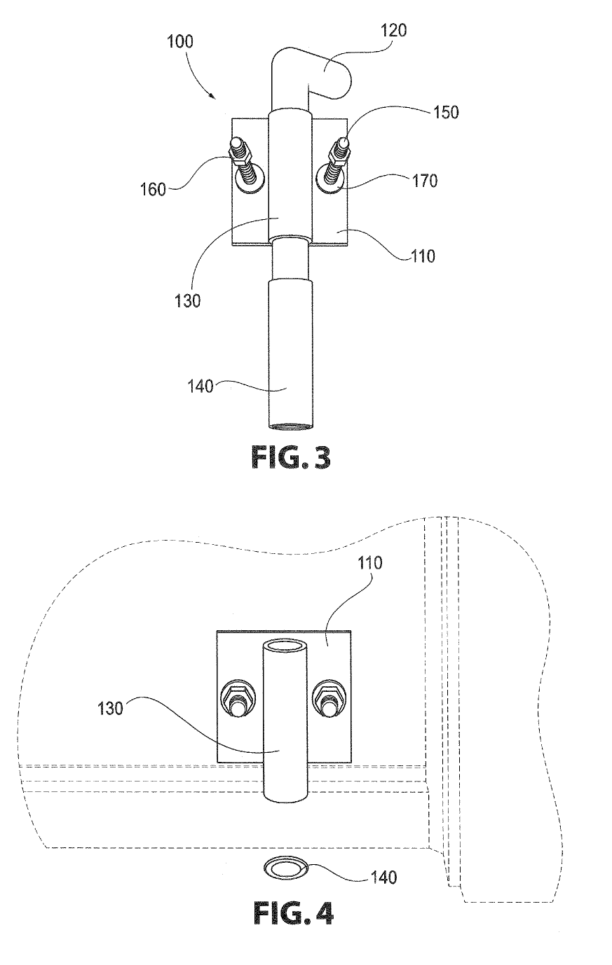

Referring to FIG. 3, in one embodiment of the door barricade system 100, the bracket 110 is attached to the inside of the door via a plurality of bolts 150, a plurality of nuts 160, and a plurality of washers 170. The plurality of bolts 150 are inserted into through holes defined by the bracket 110 and into the inside of the door, thereby securing the bracket 110 to the door. The bracket 110 is not meant to be limited to only being secured by this means. Other securing means known in the art can be used to secure the bracket 110 to the door, so long as the bracket 110 remains secured to the door when force is applied to the door barricade system 100 during a breach or intrusion attempt.

In another embodiment, the bracket 110 of the door barricade system 100 is removable from the door and not directly attached to the door. The bracket 110 can correspond with a bracket system which would be attached to the door and allow the bracket 110 to be removable from the door. In one such embodiment, two separate brackets can be bolted onto the door and the bracket 110 would correspond with the bracket system in order to attach the bracket 110 to the door, while allowing the bracket 110 to be removable from the door. One such manner of the bracket 110 corresponding with the bracket system would be for the bracket 110 to be able to slide into the bracket system without being bolted to the bracket system. This is merely an exemplary embodiment and other methods known in the art of attaching the bracket 110 to the bracket system, while making the bracket 110 removable from the door, can be used.

Referring to FIG. 4, in one embodiment the door barricade system 100 places the bracket 110 on the bottom inside of the door near the edge of the door so that the distance between the pin sleeve 130 and the end sleeve 140 is small enough so that the removable puncture pin 120 is able to be inserted through and engaged with the pin sleeve 130 first and then inserted into and engaged with the end sleeve 140. The end sleeve 140 must be aligned so that the opening of the end sleeve 140 lines up with the bottom opening of the pin sleeve 130 of the bracket 110. Further, as can be seen in FIG. 4, the removable puncture pin 120 is separate from the bracket 110 and can be removed altogether from the pin sleeve 130 of the bracket 110.

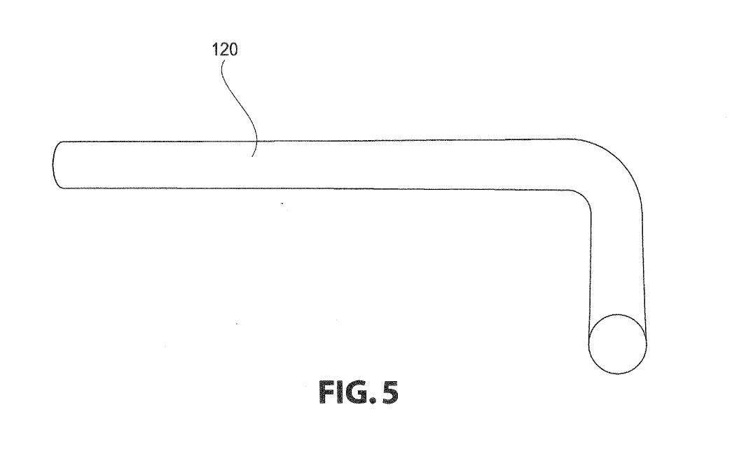

In one embodiment, the pin sleeve 130 and/or the removable puncture pin 120 can include a pin or some other means to temporarily hold the removable puncture pin 120 in place. One such embodiment would include a removable puncture pin 120 with a through hole provided going through the removable puncture pin 120 from the top of the removable puncture pin 120 through the bottom, as oriented in FIG. 5. A through hole of the same size would be provided in the pin sleeve 130 of the bracket 110 to correspond with the through hole of the removable puncture pin 120 when the removable puncture pin 120 is inserted into a locking position in the pin sleeve 130. These holes defined in the removable puncture pin 120 and pin sleeve 130 would allow for the insertion of a locking pin or carter pin. In this embodiment, the locking pin or carter pin would keep the removable puncture pin 120 in a locked position within the pin sleeve 130 and end sleeve 140.

In another embodiment, the removable puncture pin 120 could have through holes established at a lower point on the removable puncture pin 120 as well so that the removable puncture pin 120 can be lifted out of the end sleeve 140 and out of the locking position. A locking pin or carter pin could then be inserted through the through holes of the pin sleeve 130 and removable puncture pin 120 to keep the removable puncture pin 120 connected to the bracket 110 in a raised and unlocked position, so that the door can be opened and closed with the removable puncture pin 120 remaining connected with the door.

Referring to FIG. 5, in one embodiment the removable puncture pin 120 of the door barricade system 100 can have a curved top to be used as a handle. This top will allow the operator to easily grip the removable puncture pin 120 when inserting or removing the removable puncture pin 120 from the bracket 110. In another embodiment, the removable puncture pin 120 can have a straight or flat top that would make the removable puncture pin 120 flush with the pin sleeve 130.

In one embodiment, the removable puncture pin 120 and the pin sleeve 130 and/or end sleeve 140 may be threaded so that the removable puncture pin 120 could be secured to the pin sleeve 130 and/or end sleeve 140 by being tightened, similar to the tightening of a bolt. This embodiment would provide a stronger and more secure connection between the removable puncture pin 120 and the pin sleeve 130 and end sleeve 140.

Referring to FIGS. 1-4, in another embodiment the door barricade system 100 can include a plurality of brackets 110, a plurality of removable puncture pins 120, and a plurality of end sleeves 140. Each grouping of brackets 110 and removable puncture pins 120 would contain a bracket 110 attached to the inside of the door, a pin sleeve 130 attached to the bracket and a corresponding end sleeve 140 recessed into a support structure, such as the floor, wall, or door frame. Each grouping will also contain a removable puncture pin 120 to be inserted into the pin sleeve 130 of the bracket 110 and the end sleeve 140. In one example, a bracket 110 can be place on the bottom inside of the door on the non-hinged side of the door, as seen in FIG. 1, and another bracket 110 can be placed on the inside side edge of the door either directly above or below the door handle. In another embodiment, numerous brackets 110 can be placed on the bottom and on each side edge of the door. An increase in the amount of brackets 110 placed on the inside of the door can increase the barricade strength of the door barricade system.

In one embodiment, the removable puncture pin 120 can also be used as a defensive weapon in the case of an intrusion or breach, by removing the removable puncture pin 120 from the bracket 110. Alternatively, the removable puncture pin 120 can also be removed from the bracket 110 and used as a window-breaching tool. In the circumstance that the operator needs to escape from a room, the removable puncture pin 120 can be used to break the glass of a window and allow the operator to exit the room via the window.

The door barricade system 100 as described above can be constructed using steel, aluminum, brushed nickel, antique brass, chrome, and other suitable materials known in the art. It is to be understood that the use of the door barricade system 100 as described above is merely exemplary and may be modified as desired or necessitated. Exact size, measurement, construction, and design specifications may vary depending upon manufacturing and the situation in which the door barricade system is to be used.

The foregoing descriptions of specific embodiments of the present invention have been presented for purposes of illustration and description. Other examples will be apparent to, and readily made by, those skilled in the art without departing from the scope and spirit of the invention. For example, it is to be understood that this invention contemplates that, to the extent possible, one or more features of any embodiment may be combined with one or more features of any other embodiment. The exemplary embodiment was chosen and described in order to best explain the principles of the present invention and its practical application, to thereby enable others skilled in the art to best utilize the present invention and various embodiments with various modifications as are suited to the particular use contemplated. Accordingly, the foregoing description is intended to be illustrative rather than restrictive.

The invention claimed is:

1. A door barricade system, comprising:
a bracket configured to attach to an inside of a door;
a removable puncture pin;
a pin sleeve attached to the bracket;
an end sleeve recessed into a support structure;
the pin sleeve defining a through hole large enough to accommodate the removable puncture pin;
the end sleeve defining an opening large enough to accommodate the removable puncture pin,
wherein the opening defined by the end sleeve is aligned with the through hole defined by the pin sleeve; and
the removable puncture pin being able to be engaged with and inserted through the through hole defined by the pin sleeve and an end of the removable puncture pin being able to be engaged with and inserted into the opening defined by the end sleeve,
wherein the removable puncture pin being inserted into and engaging with the through hole defined by the pin sleeve and the end of the removable puncture pin being inserted into and engaging with the opening defined by the end sleeve places the door barricade system in a locked position preventing the door from being opened from the outside,
wherein the removable puncture pin being inserted into and engaging with the through hole defined by the pin sleeve and the end of the removable puncture pin remaining disengaged from the opening defined by the end sleeve places the door barricade system in an unlocked position allowing the door to be opened.

2. The door barricade system according to claim 1, wherein the bracket is attached to the door via a plurality of bolts, a plurality of washers, and a plurality of nuts, with the plurality of bolts extending into a plurality of through holes defined by the bracket and into the inside of the door, thereby securing the bracket to the door.

3. The door barricade system according to claim 1., wherein the bracket is configured to correspond with a bracket system,
wherein the bracket system is configured to be attached to the door and allows the bracket to be removed from the door.

4. The door barricade system according to claim 1, wherein the bracket is attached to a bottom inside of the door and the support structure which the end sleeve is recessed into is a floor.

5. The door barricade system according to claim 1, wherein the bracket is attached to an inside side edge of the door and the support structure which the end sleeve is recessed into is a vertical side of a door frame.

6. The door barricade system according to claim 1, wherein the bracket is attached to the inside side edge of the door and the support structure which the end sleeve is recessed into is a wall surface adjacent to a vertical side of a recessed door frame.

7. The door barricade system according to claim 1, wherein the bracket is located on a side of the door opposite a hinged side of the door.

8. The door barricade system according to claim 1, wherein a through hole is defined in the removable puncture pin and a corresponding through hole is defined in the pin sleeve so that a pin can be inserted through the through holes defined in the removable puncture pin and the pin sleeve to hold the removable puncture pin in place.

9. The door barricade system according to claim 8, wherein the through holes defined by the removable puncture pin and the pin sleeve are located so that the removable puncture pin remains engaged with the opening defined by the end sleeve and the door barricade system is maintained in a locked position.

10. The door barricade system according to claim 8, wherein the through holes defined by the removable puncture pin and the pin sleeve are located so that the removable puncture pin remains disengaged from opening defined by the end sleeve and the door barricade system is maintained in an unlocked position.

11. The door barricade system according to claim 1, wherein the removable puncture pin is threaded and at least one of the through holes defined by the pin sleeve and the end sleeve are threaded.

12. The door barricade system according to claim 1, wherein a plurality of brackets can be attached onto the inside of the door,
wherein a plurality of puncture pins are provided along with a plurality of end sleeves to correspond with the plurality of brackets.

13. The door barricade system according to claim 1, wherein the removable puncture pin can be removed entirely from the bracket and also be used as a defensive weapon or window-breaching tool.

14. A method of barricading a door with a door barricade system, comprising the steps of:
mounting a bracket onto an inside of the door at a location where the bracket is close enough to a support structure so that a removable puncture pin can engage both a through hole defined by a pin sleeve of the bracket and an opening defined by an end sleeve recessed into the support structure;
recessing the end sleeve into the support structure so that the opening defined by the end sleeve is aligned with the through hole defined by the pin sleeve of the bracket;
inserting the removable puncture pin into and through the through hole defined by the pin sleeve;
engaging an end of the removable puncture pin with the opening defined by the end sleeve to place the door barricade system in a locked position; and
disengaging the end of the removable puncture pin with the opening defined by the end sleeve to place the door barricade system in an unlocked position.

15. The method of barricading a door according to claim 14, wherein the bracket is mounted onto a bottom inside of the door and the support structure which the end sleeve is recessed into is a floor.

16. The method of barricading a door according to claim 14, wherein the bracket is mounted onto an inside side edge of the door and the support structure which the end sleeve is recessed into is a vertical side of a door frame.

17. The method of barricading a door according to claim 14, wherein the bracket is mounted to the inside side edge of the door and the support structure which the end sleeve is recessed into is a wall surface adjacent to a vertical side of a recessed door frame.

18. The method of barricading a door according to claim 14, wherein the bracket is mounted onto a side of the door opposite a hinged side of the door.

19. The method of barricading a door according to claim 14, wherein a plurality of brackets are mounted onto the inside of the door.
